(19) United States
(12) Patent Application Publication
(10) Pub. No.: US 2004/0004044 A1
(43) Pub. Date: Jan. 8, 2004

(54) Water purifier using ultraviolet radiation

(76) Inventor: Jeffrey J. Anderson, Orlando, FL (US)

Correspondence Address: ROGER M. RATHBUN, 13 MARGARITA COURT, HILTON HEAD ISLAND, SC, 29926, US

(21) Appl. No.: 10/190,048

(22) Filed: Jul. 3, 2002

(51) Int. Cl. C02F 1/32

(52) U.S. Cl. 210/748

(57) ABSTRACT

A water purifier that has a water container, preferably annular in configuration, within which the water to be purified flows in a continuous stream from an inlet to an outlet within a passageway. A UV emitter, external of the container, directs UV radiation through the water passing through the container. The passageway is a thin depth such that the UV radiation travels only a short path in penetrating the water and thus is very efficient. The UV source is located in close proximity to a thin wall of the water container to further enhance the efficiency of the UV energy. By such design, the water flows continuously through the water purifier and is purified by the time it exits through the outlet. There may be a reflective means proximate of on the outer wall of the container that reflects UV energy back toward the water passageway.

### BACKGROUND OF THE INVENTION

The present invention relates to a water purifier, and, more particularly, to a water purifier that utilizes ultraviolet radiation to carry out the purification of the water.

It is, of course, well known to utilize ultraviolet radiation in the purification of water and there are many such water purifiers that are in existence and which have been disclosed. A common theme, however, in such conventional systems of purifying the water with ultraviolet or UV radiation is that there is a container that holds the water to be purified, a source of the UV radiation and some means of sealing the source of radiation against the water container so as to get the source of radiation close to the water to allow its purifying effect and yet, at the same time, provide an adequate seal between the two components to prevent the water from leaking from the container. Thus, there have been devised, a considerable number of water purification systems that seal the source of the UV, or UV emitter, within a sealed tube, such as a quartz tube, and then locate that tube actually with the body of water to be purified.

With such systems, while the effect of the radiation is sufficient to carry out the purification process, the overall apparatus is somewhat difficult to construct and requires some type of sealing arrangement, sometimes quite complex, and there is a problem of maintaining the quartz sealed envelope clean so that the radiation can be most effective. Also, the removal and replacement of the UV emitter is a tedious task and, in many cases, requires a draining or diverting of the water within the container and a breaking and resealing of various seals that hold the UV radiation source in a water tight position within the container of the water.

For example, in U.S. Pat. No. 3,462,597 of Young, there is a water purifier utilizing a UV source contained within a quartz tube. The water continuously passes through an outer body and the UV source is located within the outer body and located in a quartz tube that is sealed within the outer body. Thus, the Young water purifier requires some wiping system to continually clean and maintain the exterior surface of that quartz body and is considerably complex. That need to carry out the internal cleaning is due, in part, to the difficulty in unsealing, removing and resealing the quartz tube containing the UV source for that system. Thus, with the Young apparatus, the need to have a rather complex cleaning system is, in part, necessitated by the difficulty to carry out routine disassembly to perform maintenance on the apparatus.

Similarly, in McRae, U.S. Pat. No. 3,485,576, the water passes through a water jacket that surrounds a UV source of radiation and, again, the UV lamp is actually located in the water and a problem occurs relating to the build up of colloidal particles on the surface of the lamp due to the presence of the UV lamp in contact with the water being purified. The same type of problem was encountered in Norris, U.S. Pat. No. 5,942,110 where there is a quartz tube that extends through the apparatus and is therefore sealed within the chamber containing the water.

In addition to the problems associated with sealing the UV source with the container of water, the aforementioned conventional systems are generally large units, intended for industrial applications, where considerable quantities of water must be purified and therefore such systems require large sources of UV energy in order to carry out that purification. The large sources of UV energy inherently have long dwell times as the efficiency of the purification process itself is dependent upon the distance of penetration, or path length x, that the UV radiation has to travel through the water in entering and passing through that water in irradiating the water. If, therefore, the body of water is large, the path length x that the UV energy must travel in penetrating the water is a long distance and therefore the efficiency is reduced and the strength of the UV energy is more dissipated the longer that path x of travel. Accordingly, with such systems, a large source of UV energy is required and the efficiency is compromised by the need to process very large quantities of water.

Accordingly, it would be advantageous to have a water purifier having a source of UV radiation that is sufficiently in close proximity to the container or conduit for the water but which is basically isolated from the water so that the problem of cleaning the quartz tube and the difficulties inherent with the removal and replacement of the source of UV radiation that is sealed within a water container are avoided.

In addition, it would be advantageous to have a small, compact water purifier, suitable for home use, that comprises a thin walled container for the water along with a position of the source of UV energy at a location that is in close proximity to the water and where the water itself is carried through the container in a thin stream so that the depth x of penetration for the UV radiation is very small and the dwell time reduced to the point that the water can simply pass through the water in a continuous flowing stream.

Thus, it would be advantage to utilize the aforementioned dimensions and materials to provide a water purifier that basically carries out a flash purification process that treats and sterilizes a continuous flowing stream of water.

### SUMMARY OF THE INVENTION

Therefore, in accordance with the present invention, there is provided a water purifier that is basically constructed contrary to the conventional thinking as to the construction of water purifiers, that is, rather than try to enclose the source of the UV radiation in a quartz tube and then seal that tube within the container filed with water, the present apparatus constructs the water container of a thin walled material, such as quartz, so that the UV source can be separate and distinct from the water container and the UV source is not therefore sealed within the container or even located within that container. It should be noted that while quartz is a suitable material for the construction of the present water container, other materials can also be used providing such materials allow sufficient UV energy to pass through the walls of the water container to irradiate and purify the water.

Thus, the water flowing through the conduit or container is unimpeded and smooth and the source of UV radiation, i.e. the lamp, can easily be removed for cleaning or replacement without any need to break a water seal or do any substantial act of disassembly of the water purifier and thus, the water purifyer does not need to be out of service for any considerable length of time in carrying out the replacement of the UV source.

The water purifier of the present invention therefore comprises a thin walled chamber, preferably comprised of quartz, that has a water inlet and a water outlet. By use of a thin walled vessel, and the close proximity of the UV source to the flowing water, the process is basically a flash sterilization and no lengthy dwell time is required. Thus, the water can be sufficiently irradiated as it flows through the water container and is sterilized by the time that the water reaches the outlet. By thin walled, the thickness of the walls of the water container can be as small as a few thousandths (2-3) of an inch, such that a thin wall container is provided for enhanced efficiency.

As such, the present invention can be constructed as small, individual units that provide good performance and which are less costly to produce. Again, due to the close proximity of the UV source to the water container, and the thin walls of the container, the UV radiation can subject the thin depth x of the water to intense radiation and therefore is very efficient since the depth of the water that the UV radiation has to penetrate is very small and the irradiation is efficient and complete as that water passes continually flowing steadily through the container.

In the preferred embodiment, the water container is formed in a annular configuration having an opening passing through the central elongated axis of the configuration and the container has an outer diameter and an inner diameter of predetermined dimensions that allow a water passageway through the annular container to be relatively thin. Thus, it is preferred that the difference in the outer diameter and the inner diameter be very small, such that the thickness of the water container, or depth of the water x that is to be irradiated, is about one sixteenth to one half inch. The source of the UV radiation, therefore can fit snugly within the inner diameter such that the source can provide a uniform and intense irradiation to the water passing through the annular container and yet be easily removed for replacement of the UV source.

In addition, the present water purifier can have an internal or external surface of the water container coated with a reflective material such that the UV energy is prevented from passing through the outer wall but is, instead, reflected back toward the water to be purified to make better and more efficient use of the UV energy that would otherwise be simply lost to the surrounding environment. As an alternative, instead of coating the exterior of the water container, there may be a reflective material wrapped around the exterior of the water container and such material can be any type of material or construction of materials with an inherent reflective surface such as aluminum foil, a particle reflective surface such as glitter impregnated film or foil, a fabricated tubular reflective surface such as a tube or pipe or a coated reflective surface such as metalized Mylar plastic film.

As alternate embodiment, the water container may be in the form of a spirally wound tube that encircles the source of the UV energy with that spiral tube is of a relatively small diameter so that the UV energy can travel through the water within the tube with a small path length x as it irradiates and purifies the water. Again, preferably, the spirally wound tube is made of quartz material but other materials can be utilized.

As a still further alternative embodiment, the water container may be in the form of a serpentine tube that winds back and forth along the length of the source of UV energy, that is, the water principally moves in alternating forward and reverse directions parallel to the main longitudinal axis of the UV bulb or source.

Other features of the present water purification system and apparatus will become apparent in light of the following detailed description of a preferred embodiment thereof and as illustrated in the accompanying drawings.

### BRIEF DESCRIPTION OF THE DRAWINGS

FIG. 1 is a side cross-sectional view of a water purifier constructed in accordance with the present invention;

FIG. 2 is an end cross-sectional view of the water purifier of FIG. 1;

FIG. 3 is a side cross-sectional view of a further embodiment of the present water purifier;

FIG. 4 is an end cross-sectional view of the embodiment of FIG. 3;

FIG. 5 is a side cross-sectional view of a still further embodiment of the water purifier of the present invention;

FIG. 6 is a perspective view of another embodiment of the present invention;

FIG. 7 is a side cross sectional view of the embodiment of FIG. 6

FIG. 8 is a perspective view of yet another embodiment of the present invention, and

FIG. 9 is an end side cross-sectional view of the embodiment of FIG. 8.

### DETAILED DESCRIPTION OF THE INVENTION

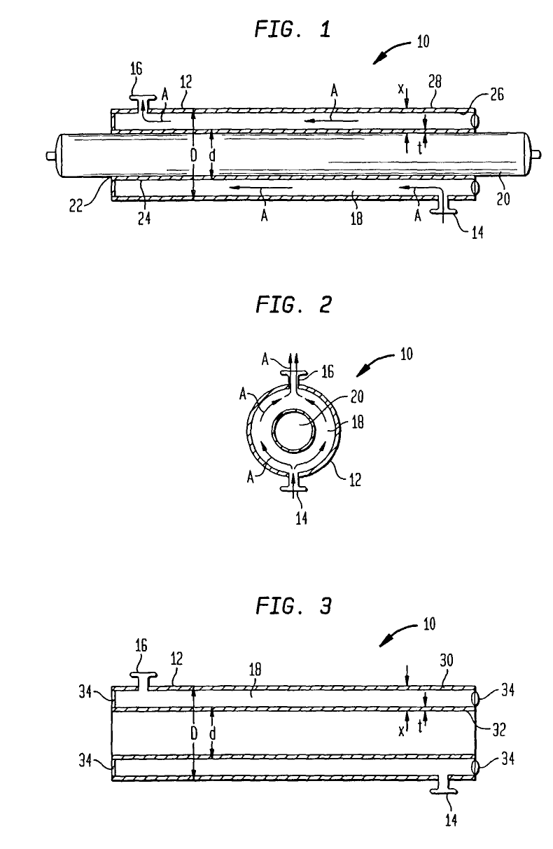

Referring now to FIGS. 1 and 2, there is shown a side cross-sectional view and an end cross sectional view, respectively, of a water purifier 10 constructed in accordance with the present invention. As can be seen in FIGS. 1 and 2, there is a water container 12 that is generally formed in an annular configuration and which has an inlet 14 and an outlet 16. Thus the annular water container 12 basically forms a water jacket and, in use, the water to be purified enters the water container 12 through the inlet 14 and exits the water container 12 through the outlet 16 and travel along a passageway 18 that is designed to be at a small or shallow depth and is shown as the dimension x in FIG. 1. The flow of water through the water container 12 is depicted by the arrows A. As will be seen, the depth x of the water that passes through the passageway 18 between the inlet 12 and the outlet 14 is an important dimension and one that makes the present invention efficient for use with relatively small water purifiers and will be discussed later.

A ultraviolet lamp 20 is interfitted into the cylindrical opening 22 formed in the annular water container 12 and which, when energized, therefore emits the radiation in the ultraviolet spectrum into and thorough the water flowing continually through the passageway 18, and that radiation passes generally normal to the direction of the flow of that water. Accordingly, therefore, the depth dimension of the water, x, is taken along the passageway 18 normal to the direction of that radiation that passes through the water.

It is also important, in the present invention, that the ultraviolet lamp 20 be located in close proximity to the passageway 18 of the water so that the radiation energy emitted by the ultraviolet lamp 20 is not diminished by traveling a long distance prior to entering the water that is to be purified. In FIG. 1, therefore, it can be seen that the ultraviolet lamp 20 is located abutting or in close proximity to the internal cylindrical surface 24 that basically forms the cylindrical opening 22 so that there is little dissipation of the radiant energy by the process of passing through the wall of the water container 12 from the ultraviolet lamp 20 to the water flowing in the passageway 18.

In the FIGS. 1 and 2 embodiment, the water container 12 is formed as a one piece blow molded component and is preferably constructed of quartz material, however other material can be used as long as that material allows the ultraviolet energy to pass through that material without detrimental diminution of the strength of the radiant energy while also having sufficient heat resistance to the heat produced by the ultraviolet lamp 20. As such, in the embodiment of FIGS. 1 and 2, the internal cylindrical opening 22 can readily be molded so as to have the predetermined desired dimensions to accept and have the ultraviolet lamp 20 interfit therein, preferably such dimensions allow the use of a conventional ultraviolet lamp 20 so as to avoid the cost of specialized sizes of such lamps. The ultraviolet lamp 20, of course, emits the radiant energy within the ultraviolet spectrum and preferably at a wavelength of about 2537 angstroms.

In order to achieve the flash sterilization of the present water purifier 10, it is also important that the particular surface that is in contact with or in close proximity to the source of the ultraviolet energy be a thin surface so that the radiant energy can readily pass through that surface without detrimentally reducing the strength and intensity of that radiant energy. Accordingly, in the FIGS. 1 and 2 embodiment, the thickness of that internal cylindrical surface is a thickness t, and is less than about ½ inch wall thickness of quartz material, however since the thickness of the cylindrical surface should approach that of a film, the thickness can be a little as a few thousands of an inch and the material may be a material other than quartz.

With a thickness t, of the aforementioned magnitude, very little of the ultraviolet radiation is prevented by the inner wall of the water container 12 from entering into the passageway 18 to irradiate the water passing therethrough. As a further efficient use of the ultraviolet energy, the internal surface 26, or even the external surface, of the outer wall 28 of the water container 12 can be coated with a reflective material such that the ultraviolet energy will not escape through that external wall 28 but will be reflected back into the water to further utilize that otherwise lost energy. As indicated, as an alternative to a coating, the outer wall 28 can be wrapped with a reflective material such as a foil, including aluminum foil, or a plastic reflective material such as Mylar plastic.

In preferred embodiment, the outer diameter D of the water container 12 is about 3 inches and the inner diameter d is just slightly less that the outer diameter so that the path of the UV radiant energy through the water, or depth x of the water that is traversed by the radiant energy is about one sixteenth to one half an inch, it being seen that the thickness of the walls of the water container 12 are sufficiently thin so as to basically be ignored in calculating or dimensioning the preferred depth x of the water within the passageway 18. The thickness of the walls will normally be thin and range from a micro inch dimensions of 1 tenth of one thousandths of an inch to one inch but may be lessor or greater in actual thickness.

Accordingly it can now be seen, with respect to the FIGS. 1 and 2 embodiment, the overall water purifier 10 is compact and is usable in relatively low flow, non-industrial applications and therefore can effectively take advantage of its high efficiency use of the ultraviolet energy. As examples, with the aforementioned dimensions of the preferred embodiment, and a standard ultraviolet lamp, there is essentially a flash sterilization that takes place, that is, the water is sufficiently sterilized as it continually passes from the inlet 14 the outlet 16 and there is no need to stop the flow of the water to allow some dwell time to take place to carry out the purification process. With the present water purifier, therefore, the purifier is cost effective and can provide a continual supply of purified water for certain applications.

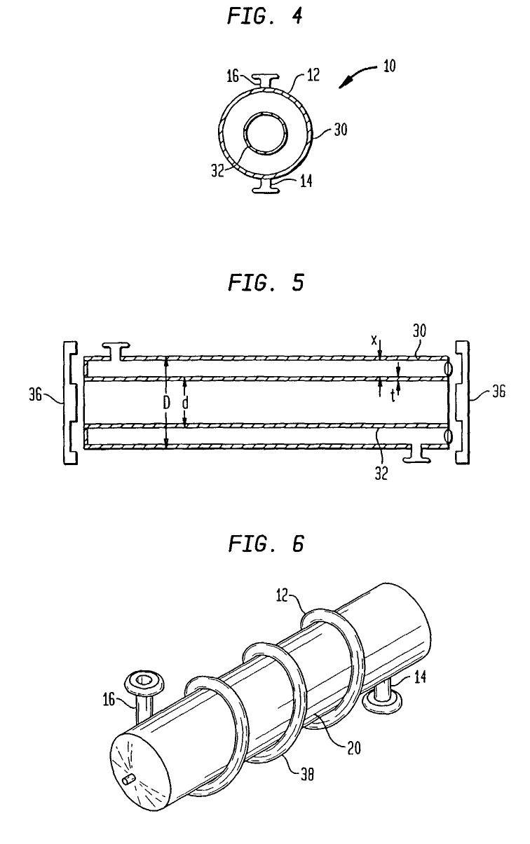

Turning now to FIGS. 3 and 4, there is shown a side cross-sectional view and an end cross-sectional view, respectively, of an alternate embodiment to that of FIGS. 1 and 2. In the FIGS. 3 and 4 embodiment, instead of a one piece molded construction, the water container 12 is comprised of a pair of cylinders, that is, an outer cylinder 30 and an inner cylinder 32 that are dimensioned similar to that of the FIG. 1 and FIG. 2 embodiment.

In this embodiment, it can be seen that the inner and outer cylinders 32, 30 are sealed at the ends thereof, such as by a sealing material 34 interposed between the ends of those cylinders to create the passageway 18 that is watertight and, still, provides an annular passageway 18 much in the same manner as in FIGS. 1 and 2. Again, since the ultraviolet lamp (not shown in FIGS. 3 and 4) would be interfifted within the inner cylinder 32, the wall thickness t of the inner cylinder 32 is relatively thin, generally less than about ½ inch and can be as small as a few thousandths of an inch, so that the passage of the ultraviolet energy is not impeded to any great extent as it passes into the passageway 18 to irradiate the water passing therethrough.

Typical of such sealing material 34 can be an epoxy cement to construct the leak proof juncture between those cylinders and which may, as in the prior embodiment, be made of quartz material, however, other UV transmitting materials can be used. The inner and outer cylinders 32, 30 have, respectively, a diameter d and a diameter D that combine to produce a passageway 18 having a therein a predetermined depth of the water passing therethrough and again, preferably that depth x may be about one sixteenth to one half inch.

Turning now to FIG. 5, there is a further embodiment of the present invention and where there is shown a side cross-sectional view of an embodiment wherein there are a pair of cylinders, that is, there is an outer cylinder 30 and an inner cylinder 32 as shown in FIGS. 3 and 4, but there are end caps 36 that seal the ends of those cylinders 30, 32. The end caps 36 can be adhesively secured to the ends of the cylinders 30, 32 and can be made, preferably, of a stainless steel or a plastic construction.

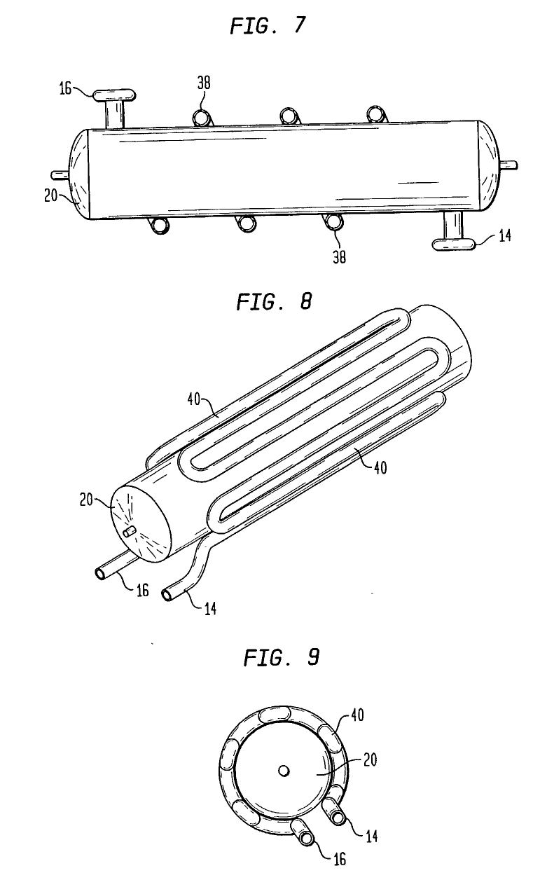

Turning now to FIGS. 6 and 7, there is shown a perspective view and a side cross-sectional view, respectively, of a still further embodiment of the present invention and wherein the water container 12 is a spirally configured tube 38 that spirally surrounds the exterior of the ultraviolet lamp 20. In this case, the spiral tube 38 can be circular in cross section for the passage of water therethrough and therefore the inside diameter of the spiral tube 38 is the critical depth x of the water as it progresses from the inlet 14 to the outlet 16.

Thus, the inside diameter of that spiral tube 38 is about ¼ to about ½ inches and the spiral tube 38 is preferably, but not necessarily, constructed of a quartz material so that the ultraviolet lamp 20 can direct its radiant energy through the water passing through the spiral tube 38. In this embodiment, the wall thickness of the spiral tube 38 can be from about 1/16 to about ½ inch but can be as small as a few (2-3) thousandths of an inch such that the impact of the radiant energy from the ultraviolet lamp 20 can rapidly sterilize the water that can, therefore, continuously pass through the spiral tube 38 since, again, no lengthy dwell or residence time is required due to the predetermined dimensions and materials used for the various components.

Turning now to FIGS. 8 and 9, there is shown a perspective view and an end view of a further embodiment of the present invention. In this embodiment, the water container 12 is a serpentine tube 40 that winds back and forth along the exterior surface of the ultraviolet lamp 20 in a serpentine manner such that the water to be purified travels in a forward and reverse direction along the longitudinal axis of that ultraviolet lamp 20 as the water passes from the inlet 14 to the outlet 16.

It will be understood that the scope of the invention is not limited to the particular embodiment disclosed herein, by way of example, but only by the scope of the appended claims.

I claim:

1. A water purification system, said system comprising a container having an exterior surface and having an inlet and an outlet and a thin passageway extending between said inlet and said outlet through which water is adapted to pass from said inlet to said outlet, a source of UV radiation located in close proximity to said exterior surface of said container so as to direct UV radiation through the container to enter the water passing through said thin passageway within said container.

2. A water purification system as defined in claim 1 wherein said container is annular in configuration having an outer cylindrical wall and an inner cylindrical wall forming an elongated opening therein along the longitudinal axis of said annular container, and said UV source is located in close proximity to the exterior surface of said inner cylindrical wall.

3. A water purification system as defined in claim 2 wherein the thickness of said inner wall of said container is less than about ½ inch.

4. A water purification system as defined in claim 3 wherein the thickness of said inner wall of said container about a few thousandths of an inch.

5. A water purification system as defined in claim 2 wherein said container is a one piece quartz injected molded construction.

6. A water purification system as defined in claim 1 wherein said container comprises an inner and an outer, coaxially aligned, cylinders to form, respectively, the inner cylindrical wall and said outer cylindrical wall, and said inlet and outlet are formed in the outer cylinder, said container having a sealing means sealing the ends of said inner and said outer cylinders together.

7. A water purification system as defined in claim 6 wherein said sealing means comprises caps located and sealed to the ends of said inner and outer cylinders.

8. A water purification system as defined in claim 2 wherein said outer cylindrical wall is coated with a reflective coating to reflect the UV radiation back toward water passing through said passageway.

9. A water purification system as defined in claim 2 wherein said outer cylindrical wall is wrapped with a reflective material of metal or plastic to reflect the UV radiation back toward water passing through said passageway.

10. A water purification system as defined in claim 6 wherein the thickness of said inner cylindrical wall is less than about ½ inch.

11. A water purification system as defined in claim 6 wherein the distance x between said inner wall and said outer wall is between about one sixteenth to about one half inch.

12. A water purification system as defined in claim 1 wherein the width of said thin passageway is about 1/16^{th} inch.

13. A water purification system as defined in claim 1 wherein said source of UV radiation is an ultraviolet lamp.

14. A water purification system as defined in claim 1 wherein said thin passageway winds spirally about said ultraviolet lamp.

15. A water purification system as defined in claim 1 wherein said thin passageway winds back and forth in a serpentine path about said ultraviolet lamp.

16. A system for the purification of water, said system comprising a container having an inlet and an outlet and a thin passageway extending between said inlet and said outlet, means to introduce water into said inlet and to force the water to pass through said passageway to exit through the outlet, said container having an exterior surface, and a source of UV radiation located in close proximity to said exterior surface of said container so as to direct UV radiation through the container to enter the water passing through said thin passageway within said container.

17. A system for the purification of water as defined in claim 16 wherein said thin passageway is from about one sixteenth to one half inch normal to the radiation emitted from the source of radiation.

18. A system for the purification of water as defined in claim 16 wherein said container is an annular container having an outer wall and an inner wall and wherein said source of radiation is located in close proximity to said inner wall.

19. A system for the purification of water as defined in claim 16 wherein the thickness of said inner wall is less than about 1 inch.

20. A system for the purification of water as defined in claim 19 wherein the thickness of said inner wall is about 1/10^{th} of one thousandths of an inch to about ½ inch.

21. A method of purifying water by means of a UV source, said method comprising the steps of:
providing a container that is transparent to radiation in the ultraviolet spectrum, and having an inlet and an outlet and a thin passageway for the water between the inlet and the outlet,
continuously passing water through the container form the inlet to the outlet,
providing a source of ultraviolet radiation,
positioning the source of ultraviolet radiation in close proximity to the container for the water to allow the ultraviolet radiation to enter the water continuously passing though the container.

22. A method of purifying water as defined in claim 19 wherein said step of providing a container comprises providing a quartz container.

23. A method of purifying water as defined in claim 19 wherein said step of providing a container comprises providing an annular container having an inner and an outer cylindrical wall, and said step of positioning the source of ultraviolet radiation comprises positioning the source of radiation proximate to the inner cylindrical wall.

24. A method of purifying water as defined in claim 20 wherein the step of providing a container comprises providing a container with the inner wall having a thickness of less than about ½ inch.

25. A method of purifying water as defined in claim 24 wherein the step of providing a container comprises providing a container with the inner wall having a thickness of about 1/10^{th} of one thousandths of an inch.
